(19) United States
(12) Patent Application Publication
(10) Pub. No.: US 2024/0084416 A1
(43) Pub. Date: Mar. 14, 2024

(54) RECOVERY OF METAL FROM LEACH PROCESSING

(71) Applicant: EXTRAKT PROCESS SOLUTIONS, LLC, Bowling Green, KY (US)

(72) Inventors: Christian KUJAWA, Bowling Green, KY (US); William R FLORMAN, Bowling Green, KY (US)

(73) Assignee: EXTRAKT PROCESS SOLUTIONS, LLC, Bowling Green, KY (US)

(21) Appl. No.: 18/272,834

(22) PCT Filed: Jan. 24, 2022
(86) PCT No.: PCT/US2022/013446

§ 371 Date: Jul. 18, 2023

Related U.S. Application Data
(60) Provisional application No. 63/147,981, filed on Feb. 10, 2021.
(60) Provisional application No. 63/140,548, filed on Jan. 22, 2021.

(51) Int. Cl. C22B 3/04; C22B 3/22; C22B 26/12

(52) U.S. Cl. CPC C22B 3/04; C22B 3/22; C22B 26/12

(57) ABSTRACT

A process of leaching a metal or salt thereof from a feed source includes combining an indifferent salt to a leach system to increase efficiency of the leach process as well as the subsequent leach residue liquid-solids separation. The process can include combining the feed source with a leaching reagent and an indifferent salt in a leach medium to form a feed slurry and leaching a metal or metal salt from the feed slurry in to a pregnant leach liquor followed by recovering metal salts from the pregnant leach liquor and recycling residual leach solution to form additional feed slurry. Such processes are suitable for large scale operations with high solids loading in the liquid-solids separation operations.

### CROSS-REFERENCE TO RELATED APPLICATION

This application claims the benefit of U.S. Provisional Application No. 63/140,548, filed 22 Jan. 2021, and U.S. Provisional Application No. 63/147,981, filed 10 Feb. 2021, the entire disclosures of both of which are hereby incorporated by reference herein.

### TECHNICAL FIELD

The present disclosure relates to recovering one or more metals or salts thereof from rock, ore, waste materials, etc. by leaching comminuted or crushed feed materials with a leach reagent and indifferent salt which improves leach performance through improved dissolution as well as recovery of a pregnant solution from of the leach residue solids. Precious metals such as gold, silver, platinum, palladium and other valuable metals such as lithium, copper, nickel, cobalt, tin, lead, aluminum, antimony, magnesium, manganese can be recovered by processes of the present disclosure.

### BACKGROUND

Metals can be recovered from metal bearing rock, ore or waste materials by a leach system such as an acid or alkaline leaching system etcetera. Water is typically used in such a process as well as a transport medium in such leach operations. Conventional processes for leaching metals from ore require diluting a slurry with subsequent thickening and often also filtration of solids to achieve effective liquid-solids separation.

When a high amount of clays or other small micron sized particles are present, the leach is hindered because of worse slurry rheology and poor contacting and therefore dissolution mechanics. Often post leach liquid-solids separation becomes so difficult that the necessary pregnant solution separation from the leach residue makes the whole process uneconomical.

There is a need to improve the performance of leaching metals from feed materials as well as a need to improved liquid-solids separation of a pregnant solution from leach residue.

### SUMMARY OF THE DISCLOSURE

Advantage of the present disclosure is the combined improvement of both the leach dissolution as well as subsequent pregnant solution recovery from the residue solids.

Advantages of the present disclosure results in increased leach rates due to increased ionic activity in the leach. These and other advantages are satisfied, at least in part, by a process of leaching a metal in a leach medium including a leaching reagent and indifferent salt to increase the leach rate.

An additional advantage of the present disclosure is the reduction in dissolution of minerals introducing impurities to the pregnant solution.

Additional advantages of the present disclosure include improved liquid-solids separation such as increased efficiency in an amount of liquid-solids separation at a constant feed solids concentration and throughput or at a higher specific throughput rate at constant feed solids concentration and thickener and filter separation performance. Such improvements translate to smaller apparatus requirements and lower operating costs. Further, such processes are suitable for large scale operations with high solids loading in the liquid-solids separation operations.

Further advantages entail requiring less feed dilution and mixing of the leach slurry to achieve acceptable flocculation which translates to a smaller thickener or elimination of thickeners from the process.

These and other advantages are satisfied, at least in part, by a process of leaching a metal from a feed source by combining the feed source with a leaching reagent and an indifferent salt in a leach medium to form a feed slurry; leaching a metal or salt thereof from the feed slurry to form a leach slurry containing a pregnant leach liquor having metal salts dissolved therein and leach solids residue; separating the pregnant leach liquor from the leach solids residue; recovering metal salts from the pregnant leach liquor and forming a residual leach solution having a concentration of the indifferent salt dissolved therein of at least about 0.4 wt %; and recycling the residual leach solution to form additional feed slurry.

The processes of the present disclosure are suitable for large scale operations such as in the mining industry and can form feed slurry a rate of at least two metric tonnes in a 24 hour period, e.g., feed slurry is formed at a rate of at least 1-2 metric tonnes in a 10 hour period such as at a rate of least 1-2 metric tonnes in a 5 hour period, or 1 hour period. The processes of the present disclosure are also suitable for liquid-solids separation operations (thickener and/or filtration) in which a slurry has a high solids concentration, e.g., greater than 10 wt % solids, such as greater than 15 wt % solids and greater than 20 wt %, 25 wt % and even higher than 50 wt % of solids during the liquid-solids separation operation.

Such leaching operations can be used with high clay content ore or rock such as sedimentary rock that is composed primarily of clay-sized particles, e.g., claystone, mudstone, etc. In an aspect of the present disclosure, the process includes leaching a clay rich material, e.g., an ore or rock having more than 30% clay sized particles of less than 10 microns.

Ores are often leached at solids concentrations not unlike that of a thickener underflow. Advantage of the present disclosure is an effective flocculation at an elevated solids concentration, thus making possible additional dewatering of the leach slurry by gravity or mechanical separation after flocculation without the extensive dilution required for the flocculation conventionally.

An additional advantage of the present invention is the accelerated dewatering under compression. The increased dewatering rate under compressions holds for membrane press pressure filtration with pressures up to 25 bar, but also for the consolidation in tailings storage facilities under self-weight compression.

Another advantage of processes of the present disclosure is that the residual leach solution includes a high concentration of the indifferent salt and can be recycled back to the leach system operation to form additional leach slurry which significantly improves the economics of the process.

Embodiments include one or more of the following features individually or combined. For example, in some aspects, the feed source including a metal or metal salt can comprise rock, ore or a waste material such as from spent electronic equipment such as spent batteries, or spent circuit boards, which can contain precious metals such as gold, silver, platinum, palladium, etc. and other valuable metals such as lithium, copper, nickel, cobalt, tin, lead, aluminum, antimony, magnesium, manganese, etc. In other embodiments, the leach medium is at a temperature of at least 30° C. In further embodiments, water for the leach medium or the leach medium is heated by a natural source.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1 is a schematic illustration of a leach flowsheet that can be used in practicing certain aspects of the present disclosure.

FIG. 2 is another schematic illustration of a leach flowsheet that can be used in practicing certain aspects of the present disclosure.

### DETAILED DESCRIPTION OF THE DISCLOSURE

The present disclosure includes leaching a feed source including a metal or metal salt with a process that includes an indifferent salt to improve the overall process of metal or metal salt dissolution in the leach step and to improve the liquid-solids separation step in the process. The feed source including a metal or metal salt can comprise rock, ore or a waste material such as from spent electronic equipment such as spent batteries, or spent circuit boards, which can contain precious metals such as gold, silver, platinum, palladium, etc. and other valuable metals such as lithium, copper, nickel, cobalt, tin, lead, aluminum, antimony, magnesium, manganese, etc.

A leaching process typically starts with crushing the feed source and transporting or adding water to the feed source. In aspects of processes of the present disclosure, a leaching reagent and an indifferent salt in a leach medium is combined with the feed source to form a feed slurry.

Leaching metals or metal salts from a waste material can include crushing the waste material and separating undesirable solids, e.g., scrap paper, plastics, outer metallic bodies, and optionally sieving the crushed material to a certain size followed by a leaching operation as disclosed in the present disclosure.

As used herein an indifferent salt is a salt that is highly soluble in water, disassociating in to one or more cations and anions, and remains dissolved in an aqueous phase of the leaching process without precipitating from a slurry throughout the process and remains dissolved in any recycled aqueous liquid. The disassociated cations or anions of the indifferent salt further do not chemically react to form coagulates or chemically react with components of a slurry such as polymer flocculant during the process or undergo oxidation or reduction reactions during the process. Such indifferent salts are advantageous since they remain dissolved in the aqueous phase of compositions and can be substantially recovered in an aqueous phase and thus subsequently used to treat additional ore or slurry.

The objective of leaching rock and ore is to liberate and dissolve one or more target metals (or salts thereof) such as precious metals, such as gold and silver, base metals, platinum group metals, rare earth elements, heavy metals, alkali metals such as lithium, and alkaline metals, etc. At times, additional complexing agents such as for example in precious metal extraction, thiourea or commonly cyanide are added to ensure that the liberated metals remain in solution, typically called a pregnant solution. Some complexing agents can be specific to certain metals. Once the target metals are in solution, separation of the solution from the unwanted remaining solids is an effective separation and often simultaneous upgrading method. The metals are selectively removed from the pregnant solution by a variety of methods such as for example precipitation, cementation, electrolysis, or carbon or resin loading. This selective removal upgrades the metal content further.

Leaching metal-based rock or ore includes mechanical destabilizing the ore, e.g. crushing, grinding, milling (including high energy milling), followed by extracting the metal with a leaching reagent, typically in an aqueous medium, to convert the target metal into soluble salts that can be separated from unwanted solids. Leaching reagents include cyanide, acids, such as sulfuric acid, hydrochloric (HCl) acid, etc. In certain aspects of the present disclosure, an indifferent salt is used as an augmenting reagent in a leach system, particularly in an acidic leach system. Certain indifferent salts are known to increase dissolution rates of metals from ore. Further, indifferent salts can improve liquid-solids separation of the leach slurry and thus further improve the efficiency of the metal recovery process.

Use of chlorides, e.g., including HCl acid, for leaching metals such as gold is known but has not found significant commercial use because of problems associated with corrosion due to high chloride concentrations in leach solutions, among other issues. However, chloride leach systems have a few advantages. The chloride chemistry is well understood. The chemistry is clean in that outcomes can be readily predicted, and the chemistry readily controlled. The main chemical advantages of the chloride leach system are: (1) Higher ionic activities are possible and therefore also higher reaction rates which results in smaller leach equipment; (2) The solubilities of many metals are higher because of complexing, resulting in higher leach recoveries and also in higher concentrations in the leach product solution which in turn results in higher metal recoveries in the recovery step; (3) The chloride leach system allows selective metal separation; (4) Often the lixiviant regeneration is more straightforward; (5) The energy consumption for subsequent electrolysis if used is lower due to the higher electrolyte solution conductivity. The chloride low pH leach is typically only used for materials with few acid-consuming minerals, thus limiting the acid consumption. The chloride leach can be either low-pH oxidative, low-pH non-oxidative.

An indifferent salt, such as sodium chloride, also can be used as an augmenting reagent in a chloride leach system. For example, addition of sodium chloride is known to increase the chloride activity, thereby improving a chloride leach.

In one specific application, refractory gold or silver ores are extracted from the host mineral in a chloride leach in which sodium chloride is used to enhance the leach kinetics. Ferrous chloride addition to the system is used to control the electrochemical potential (Eh). At certain pH and with an electrochemical potential controlling reagent the chloride acts as a complexing ligand to keep gold and silver in solution, thus eliminating the need of cyanide or other complexing agents such as thiourea to keep the precious metals in solution allow separation from the remaining not leached gangue solids by liquid-solids separation, be it thickening or filtration or filtration with a filter cake wash. The gold and silver are readily precipitated from the pregnant solution and once precipitated can be recovered again by liquid-solids separation as a concentrate from the remaining barren solution.

In the case of lithium extraction, processes of the present disclosure can improve the economics of recovering the lithium from lithium-hosted, lithium-rich clays or clay-rich lithium minerals. The presence of lithium in clays can be as impurities, as inclusions, in lattice cavities, by adsorption on particle surfaces or edges or by isomorphous substitution. These clays present a challenge in the dewatering of the leach residue and the efficient recovery of the pregnant solution from the leach residue consisting of clays.

However, processes of the present disclosure are suitable for high clay content ores such as sedimentary rock that is composed primarily of clay-sized particles, e.g., claystone, mudstone, etc. In an aspect of the present disclosure, the process includes leaching a clay rich ore, e.g., an ore having more than 30%, 40%, 50% of clay sized particles of less than 10 microns.

In another aspect of the present process, lithium can be leached from sedimentary rock, such as claystone found in Nevada, USA, by treating such rock with an leach medium that includes a high concentration of an indifferent salt (without an acid or chloride source).

A total dissolved indifferent salt concentration of the indifferent salt should preferably be on solution basis at least of at least 0.5 wt % and preferably no less than about 0.75 wt %, such as at least about 1 wt %, 1.5 wt %, 2 wt % and even at least about 2.5 wt % 3 wt %, 4 wt %, 5 wt %, 10 wt % etc. In addition, the leach medium is preferably at a temperature of at least about 20° C., such as at least about 25° C., 30° C., 32° C. (about 90° F.), 33° C., 35° C., 37° C. (about 99° F.), 38° C. (about 100° F.), 40° C., 42° C., 45° C. Advantageously, water used for the leach medium or the leach medium itself can be heated by natural sources, i.e., sources of heat that occur naturally at a leach site, such as by solar radiation, geothermal heating, and/or other natural sources available at the site for a large scale operation.

The addition of an indifferent salts such as is the case with sodium chloride to a slurry system can also markedly improve flocculation, floccule aggregation, settling and consolidation of particles from a slurry with a clear release of solution. The flocculation and subsequent dewatering are improved with or without addition of polymer flocculant, although the addition of a nominal amount of polymer flocculant further disproportionally improves liquid-solids separation performance.

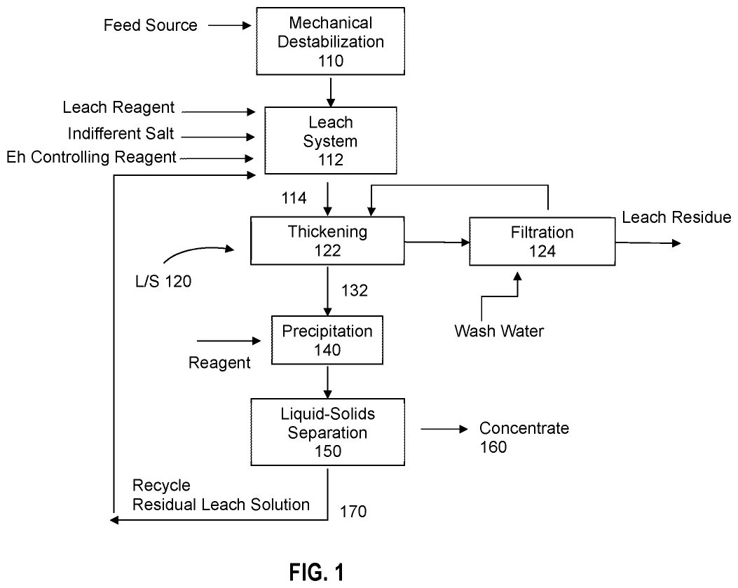

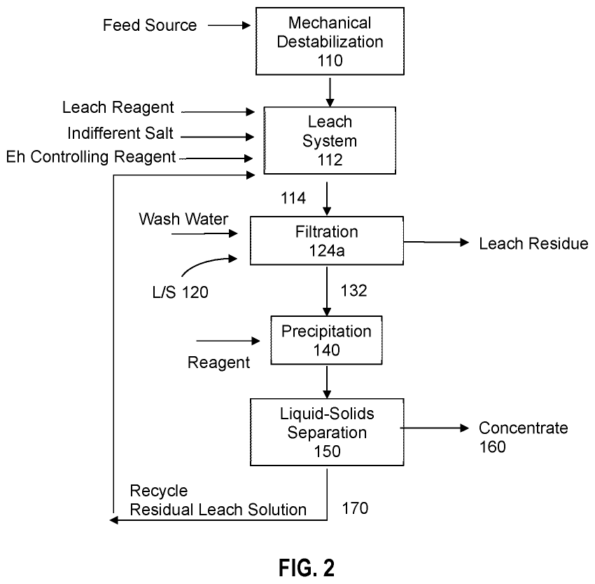

FIGS. 1 and 2 illustrate generalized leach system flowsheets. As illustrated, a feed source is provided to a mechanical destabilizer (110). The feed source can comprise ore, rock etc. including one or metals of interest. The feed source can also comprise, or alternatively comprise, a waste material such as from spent electronic equipment, e.g., spent batteries, spent circuit boards, etc., which include one or metals of interest. Metals of interest from such feed sources can include gold, silver, platinum, palladium, etc. and other valuable metals such as lithium, copper, nickel, cobalt, tin, lead, aluminum, antimony, magnesium, manganese, etc.

The mechanical destabilizer (110) can grind, mill, such as high energy mill, crush, etc. the feed source to liberate solid particles and promote the leach process. The mechanically destabilized feed source can then be sent to a leach system (112) in which a feed slurry is formed by combining the feed source with a leach medium including water with one or more leaching reagents and one or more indifferent salts. In one aspect of the present disclosure, the leach reagent includes an acid such as HCl for a chloride leach system. Other or additional leach reagents can also be used to implement a chloride leach, such as for example ferric chloride or hypo chloride. An electrochemical potential controlling reagent, if needed, can be added and can be either be an oxidant such as oxygen or hydrogen peroxide in the case of an oxidative leach, or a reducing agent such as ferrous chloride, alcohol or hydrocarbon required in a non-oxidative leach. Most metals are soluble in a chloride leach medium through complexing. For example, depending on the electrochemical potential gold and silver are complexed by the chloride in the medium and remain soluble. In the case of lithium leach, a chloride leach is especially favorable due to the high solubility of lithium chloride. A number of chloride process leach routes are possible. One such route is the roasting of ore feed in the presence of a chloride source, such as for example potassium chloride. Other chloride sources are also possible. Lithium in a lithium containing ore can be converted in the roast to lithium chloride which then on contacting with water will leach due to the high solubility of lithium chloride in water. This process route is more applicable for lithium ores refractory to an acid leach and when lithium is present in the clay through isomorphous substitution, as for example in Hectorite.

Another process route is the direct leach of lithium with acid, of which one possibility is hydrochloric acid. The presence of the indifferent salts increases the chloride concentration which improves the leach kinetics. The addition of an indifferent salt can reduce the leach of higher valent ion and therefore unwanted impurities. Further, the indifferent salt together with a polymer flocculant improves liquid-solids separation of high clay ore.

The target metal or metals are leached from the feed slurry in leach system (112) with the leach medium to form a leach slurry (114) containing a pregnant leach liquor of metal salts and leach solids residue. Advantageously, water used for the leach medium or the leach medium itself can be heated by natural sources to a temperature of at least about 20° C., such as at least about 25° C., 30° C., 32° C. (about 90° F.), 33° C., 35° C., 37° C. (about 99° F.), 38° C. (about 100° F.), 40° C., 42° C., 45° C. The pregnant leach liquor and leach solids residue of the leach slurry are then separated.

Processes of the present disclosure are suitable for large scale operations such as in the mining industry and can form feed slurry a rate of at least two metric tonnes in a 24 hour period, e.g., feed slurry is formed at a rate of at least 1-2 metric tonnes in a 10 hour period such as at a rate of least 1-2 metric tonnes in a 5 hour period, or 1 hour period. With such large scale operations thickeners are employed to increase the rate of processing the feed material during the operation.

As illustrated in FIG. 1, leach slurry (114) can undergo a liquid-solids separation operation (120) such as by thickening (122) followed by filtration (124), e.g., bed filtration, can be used to separate the pregnant leach liquor from the leach solids residue. The liquid-solids separation can be implemented using other liquid-solids separation systems such as for example centrifuging, crossflow filtration or counter-current decantation. An advantage of the processes of the present disclosure is that the liquid-solids separation operation (thickening and/or filtration) can be carried out with a leach slurry having a high solids concentration, e.g., greater than 10 wt % solids, such as greater than 15 wt % solids and greater than 20 wt %, 25 wt % and even higher than 50 wt % of solids during the liquid-solids separation operation.

Typically, the filter cake (leach solids residue) is washed (wash water) to recover as much of the pregnant solution as possible. Filtration is an attractive liquid-solids separation technology as the dilution of the leach solution within the circuit is minimized. Leach residues high in clay are typically difficult to filter, often rendering the whole leach extraction process uneconomical. The presence of clays will also introduce operational issues in terms of cloth blinding and residual sticky cake adhering to the cloth prevent proper filter press closure, causing operational maintenance costs and loss valuable online filtration time or loss in throughput. However, we found that by including a sufficiently high concentration of indifferent salt with in the leach medium during the leaching operation allows liquid-solids separation by filtration even with feed materials high in clays. In addition, filtration of the leach slurry can be carried out at a high solids concentration.

FIG. 2 shows a liquid-solids separation operation that does not include a thickening step in which leach slurry (114) can undergo a liquid-solid separation directly by filtration (124a). That is, separating the pregnant leach liquor from the leach solids residue can occur directly from the leached slurry (114) by filtration without a prior thickening step even with a high solids loading and in a large scale operations in which feed slurry and/or leach slurry is formed a rate of at least two metric tonnes in a 24 hour period, e.g., the slurry is formed at a rate of at least 1-2 metric tonnes in a 10 hour period such as at a rate of least 1-2 metric tonnes in a 5 hour period, or 1 hour period. Such a filtration step can be carried out with the leach slurry having a high solids concentration e.g., greater than 10 wt % solids, such as greater than 15 wt % solids and greater than 20 wt %, 25 wt % and even higher than 50 wt % of solids during filtration.

Typically, the leach solids residue, e.g., filter cake, is washed (wash water) to recover as much of the pregnant solution as possible. As explained for FIG. 1, filtration is an attractive liquid-solids separation technology as the dilution of the leach solution within the circuit is minimized and filtration is enhanced by including a sufficiently high concentration of indifferent salt with in the leach medium during the leaching operation.

Metal salts dissolved in the pregnant solution can be selectively recovered by a variety of methods such as for example precipitation, cementation, electrolysis, or carbon or resin loading. As shown in the examples of FIGS. 1 and 2, metal salts can be recovered from the pregnant leach liquor (132) by adding reagents that precipitate the metal salts in a precipitation operation (140). However, other recovery mechanisms such as for example cementation, electrolysis, carbon or resin loading can be used in place of or in addition to precipitation.

In the case of precipitation or cementation, the metal or metal salts precipitated as solid form can be removed from the remaining now essentially barren solution (leach solution) by another liquid-solid separation system operation (150). In this example, a product slurry is formed by precipitated metal or metal salts in a residual leach solution and the solids are separated from the product slurry.

Such a liquid-solid separation system operation can include, for example, thickening followed by filtration to form a concentrate (160) of the metal and metal salts and a residual leach solution (170). However, other liquid-solid separation systems can be used in place of or in addition to by thickening followed by filtration such as for example centrifuging, crossflow filtration or counter-current decantation. Depending on the chemistry a leach solution regeneration step might or might not be required.

An advantage of the processes of the present disclosure is that the liquid-solids separation operation (thickening and/or filtration) of the product slurry can be carried out with a product slurry having a high solids concentration, e.g., greater than 10 wt % solids, such as greater than 15 wt % solids and greater than 20 wt %, 25 wt % and even higher than 50 wt % of solids during the liquid-solids separation operation even in a large scale operation. Further, precipitated metal and/or metal salts can be directly filtered from the residual leach solution to form the concentrate (160) without a prior thickening step even in large scale operations. That is, separating metal salts from the pregnant leach liquor in the product slurry can occur directly from the product slurry by filtration without a prior thickening step even with high solids loading and in a large scale operation.

Another advantage of processes of the present disclosure is that the residual leach solution (170) includes a high concentration of the indifferent salt, e.g., the same or higher concentration or very close to the same concentration of the indifferent salt, as the concentration of the indifferent salt in the leach medium at the start of the leach system 112 because the indifferent salt remains in solution during the process. There may be some increase in the amount of indifferent salt depending on the feed source or there may be some loss due to various steps in the process. However, in an aspect of processes of the present disclosure, the residual leach solution has a concentration of the indifferent salt dissolved therein of at least about 0.4 wt %, such as at least 0.5 wt % and preferably no less than about 0.70 wt %, such as at least about 1 wt %, etc. and up to and including the amount in the leach medium.

As shown in FIGS. 1-2, the residual leach solution (170) can be recycled back to the leach system operation to form additional leach slurry which significantly improves the economics of the process.

Further, an effective liquid-solids separation improves the overall efficiency of the metal recovery process. Effective liquid-solids separation steps can improve recycling of leach reagents thus limiting the cost of replenishing leach reagent in the circuit, as well as reducing downstream complications where remaining solution is unwanted.

In an aspect of the present disclosure, the overall efficiency of the leach system can be improved by including an indifferent salt to the system. The indifferent salt can be added with the leach reagents in the leach system. Alternatively, or in addition thereto, the indifferent salt can be included at the liquid-solid separation stage of the process. The addition of an indifferent salt at a sufficient concentration in the leach medium of a slurry can improve the liquid-solid separation process and thus improve the overall process of metal recovery.

As shown in the example of FIGS. 1 and 2, an indifferent salt is added in the leach system (112). For example, the chloride concentration in a chloride leach system can be increased by the addition of a soluble indifferent chloride salt. Typically, the soluble salt is added at the same time as the other leach components are added. For example, sodium chloride is one such augmenting reagent that can be added to promote the solution ionic activity. The increased ionic activity in turn improves the leach kinetics. Typically, sodium chloride concentrations of 3.5% to 5% in the leach medium are sufficient to achieve the enhanced ionic activity. The sodium chloride as ionic additive fits well into the chloride leach system. Further, including an indifferent salt can minimize subsequent unwanted precipitation reactions.

The addition of an indifferent salt to the leach process improves the subsequent liquid-solids separation step(s) and appears indifferent to the type of system employed for liquid-solids separation, thus improving the overall flowsheet efficiency. It is advantageous to include indifferent salts that do not interfere with the leach and the recovery steps. In the case of a chloride leach system, it is advantage to utilize indifferent salts of chloride, e.g., sodium chloride which is inexpensive and relatively benign.

After the feed slurry is leached, unwanted solids are removed from the process. In one aspect of the present disclosure, the aqueous medium in any slurry of the process includes a sufficient concentration of indifferent salt to improve separation of solids from the aqueous phase of the slurry. It was found that by adding indifferent salt in a sufficient quantity to a feed slurry, efficient aggregation of solid particles and efficient flocculation results. It was further found that this process is considerably more efficient than conventional coagulation methods in that flocculation can be carried out at higher feed solids concentrations, requires less mixing and is effective with minerals such as for example clays that traditionally have been refractory to liquid-solids separation. The floccule aggregates formed are more robust and less prone to shear. The flocculation is more efficient in capturing fine and ultra-fine particles, which results in a cleaner overflow liquid.

In one aspect of a process of leaching a metal from a feed source, a slurry formed from either as a leach slurry or product slurry or other slurries includes the indifferent salt at sufficient concentration that the slurry can be directly filtered to remove solids without diluting the slurry and/or without use of a thickener apparatus or thickening step. In another aspect of a process of leaching a metal from a feed source, thickeners are used to facilitate liquid-solids separation.

Advantageously, the process of the present disclosure results in an increased liquid-solids separation efficiency of at least 25% as compared to slurry without the added indifferent salt. The comparison is done at constant feed solids concentration and throughput.

When employing a thickener, the processes of the present disclosure can have as increased rate of sedimentation of solids, an increased overflow liquid throughput, and/or an increased percentage by mass of solids of thickener underflow slurry as compared to feed slurry in the thickener apparatus without the added indifferent salt. Each of the rate of sedimentation of solids, overflow liquid throughput, percentage by mass of solids of thickener underflow slurry can individually be increased by at least 25%, e.g., by at least 50%, 75%, 100%, 1²⁵% or higher, as compared to a slurry in the thickener apparatus without the added indifferent salt. The reasons for the separation efficiency improve lies in the robust nature of the formed floccule aggregates and their increased settling rate in the upper part of the thickener, as well as in the higher hydraulic conductivity and consequent higher dewatering rate of the solids bed in the lower part of the thickener, as well as the improved fines and ultra-fines capture when treating feed slurry with the indifferent salt.

In practicing aspects of the present process, thickening a slurry includes treating the slurry with at least one polymer flocculant or solution thereof. The slurry can be treated in the thickener apparatus with the at least one polymer flocculant concurrent with or subsequent to treating the slurry with the indifferent salt. The process can further comprises removing underflow slurry and overflow aqueous liquid from the sediment tank as two distinct streams.

In thickeners using conventional coagulation and flocculation reagents, the feed slurry typically is diluted prior to thickening operations to a solids concentration of concentration between 2% and 10% solids (by weight). However, an advantage of practicing aspects of the process of the present disclosure is that dilution of the slurry into a thickener or filter can be minimized and even eliminated. Hence in practicing aspects of processes of the present disclosure, the leach slurry and/or product slurry can have a solids concentration of greater than 10 wt % solids, such as greater than 15 wt % solids and greater than 20 wt %, 25 wt % and even higher than 50 wt % during liquid-solids separation operations even in a large scale operation. This significantly reduces the cost of diluting the feed. Such costs would be incurred in pumping and mixing supernatant with the thickener feed. Other costs are reduced in that the thickener feedwell is reduced in size and complexity. The thickener diameter is reduced further reducing the capital costs. The reduction in costs are at least 25% and greater than 30%, 40% and even 50%.

Further, the solids loading rate for a feed slurry treated according to processes of the present disclosure can be greater than typically achieved in thickeners. Typical solids loading rate for coarse sand is about 1.0 to 1.5 (metric tonne/hour)/meter squared ((t/h)/m²) and for typically feed slurries between about 0.3 and 1.0 (t/h)/m². Advantageously, the solids loading rate for a feed slurry to be treated with an indifferent salt and optionally polymer flocculant can be greater than 2 (t/h)/m², such at least about 2.5 (t/h)/m² and at least about 3, 3.5, 4, 4.5, 5 and 6 (t/h)/m². The improvement in solids loading rate results in a substantial reduction of thickener cross sectional area, which either translates to smaller diameter thickener or alternative less thickeners, representing a substantial savings in capital costs.

In high-rate thickeners, solids contents in the underflow are of the order of 50% by weight, depending on the nature of the feed slurry and conditions of thickener operation (feed rate, etc.) Higher solids concentrations in the underflow slurry can at times be obtained using high-density, high-compression or paste thickeners. These are taller than conventional thickeners to increase the self-consolidating weight on the solids in the formed bed. They also have steeper floor slopes to enhance the movement of settled slurry to the discharge point. The higher bed solids density of these thickeners relative to high-rate thickeners greatly increases the rake torque, requiring a higher rake drive capability. In addition, as the solids density increases near the base of the thickener, hydraulic conductivity decreases, lowering the rate of water release. High density thickeners are more expensive than high-rate thickeners and there is a trade-off between cost, the ability to pump thickener underflow and the amount of water recovered.

An indifferent salt preferably has a solubility in water of greater than 2 g of salt per 100 g of water (i.e., a salt/water solubility of 2 g/100 g) at 20° C. Preferably the indifferent salt has a water solubility of at least about 5 g/100 g at 20° C., e.g., at least about 10 g/100 g of salt/water at 20° C. Indifferent salts that are useful in practicing processes of the present disclosure include salts having a monovalent cation without multivalent cations, e.g., alkali halide salts such as sodium chloride, potassium chloride; also salts having monovalent cations without multivalent cations such as sodium and potassium nitrate, sodium and potassium phosphates, sodium and potassium sulfates, etc. are useful in practicing processes of the present disclosure. Other indifferent salts having monovalent cations useful in practicing processes of the present disclosure include ammonium based salts without multivalent cations such as ammonium chloride (NH₄Cl), ammonium bromide (NH₄Br), ammonium carbonate ((NH₄)₂CO₃), ammonium bicarbonate (NH₄HCO₃), ammonium nitrate (NH₄NO₃), ammonium sulfate ((NH₄)₂SO₄), ammonium hydrogen sulfate (NH₄HSO₄), ammonium dihydrogen phosphate (NH₄H₂PO₄), ammonium hydrogen phosphate ((NH₄)₂HPO₄), ammonium phosphate ((NH₄)₃PO₄), etc. Mixtures of such salts can also be used.

Certain ammonium-based salts are useful for practicing the present disclosure since residual ammonium-based salts on the concentrated solids can be beneficial to plant life. In fact, many of the ammonium-based salts are useful as fertilizers, e.g., ammonium chloride, ammonium nitrate, ammonium sulfate, etc. Many of the monovalent cation sulfate and phosphate salts are also useful as fertilizers. In certain embodiments of the present disclosure, the indifferent salt or salts used in the processes of the present disclosure can preferably be non-toxic and beneficial to plant life to aid in environmental remediation and the restoration of mine sites.

When a sufficiently high concentration of the indifferent salt is included in treating ore, rock or a feed slurry, the indifferent salt can destabilize and consolidate solids in a slurry. For a relatively short process times with a relatively low energy input, a total dissolved indifferent salt concentration of the indifferent salt should preferably be on solution basis at least of at least 0.5 wt % and preferably no less than about 0.75 wt %, such as at least about 1 wt %, 1.5 wt %, 2 wt % and even at least about 2.5 wt % 3 wt %. 4 wt %. 5 wt %. 10 wt % etc. Determination of the concentration of the indifferent salt dissolved in the aqueous fraction includes the amount added together with any indifferent salt that may already be part of the aqueous fraction of the feed slurry prior to addition of indifferent salt to the process.

The indifferent salt(s) can be used to treat feed slurry of the present disclosure as a solid, e.g., combining the salt as a powder with the feed slurry. Alternatively, the salt can be in a solution to treat feed slurry, e.g., by combining an aqueous salt solution with feed slurry in the thickener apparatus. In some aspects of the present disclosure, an aqueous solution of the indifferent salt can be used having a concentration of no less than about 1 wt %, e.g., greater than about 2 wt %, 3 wt %, 5 wt %, 7 wt %, 10 wt %, 20 wt %, 30 wt % and even as great as a 40 wt % or as an aqueous salt slurry. The feed slurry and indifferent salt solution should be mixed at a ratio sufficient to destabilize and consolidate solids in the slurry.

In some embodiments of the present processes, it can be more advantageous to use a natural source of the indifferent salt or salts such as in a natural body of water including such salts in sufficiently high concentration such as at least about 2 wt % and even at least about 3 wt % or greater. For example, ocean or seawater can be used as a source of indifferent salts, which can significantly improve the economics of the process under certain conditions. The vast majority of seawater has a salinity of between 31 g/kg and 38 g/kg, that is, 3.1-3.8%. On average, seawater in the world's oceans has a salinity of about 3.5% (35 g/L, 599 mM). Seawater includes a mixture of salts, containing not only sodium chloride as sodium cations and chlorine anions (together totaling about 85% of the dissolved salts present), but also sulfate anions and calcium, potassium and magnesium cations. There are other ions present (such as bicarbonate), but these are the main components. Another natural source of highly soluble salts that can be used as a source of highly soluble salts includes a hypersaline body of water, e.g., a hypersaline lake, pond, or reservoir. A hypersaline body of water is a body of water that has a high concentration of sodium chloride and other highly soluble salts with saline levels surpassing ocean water, e.g., greater than 3.8 wt % and typically greater than about 10 wt %. Such hypersaline bodies of water are located on the surface of the earth and also subsurface, which can be brought to the surface as a result of ore mining operations.

In other embodiments of the present processes, it can be advantageous to use a brine produced in desalinization of salt water as a source of an indifferent salt(s). The brine can be used alone as a source of the indifferent salt(s) or in combination with another source of indifferent salt(s) such as seawater.

Although indifferent salts can destabilize and consolidate solids in a slurry, adding one or more polymer flocculant(s) can reduced the time for sedimentation and increase overflow output. Hence, one or more polymer flocculants(s) can be added concurrent with or subsequent to treating the feed slurry with the indifferent salt in the thickener apparatus.

Polymers that are useful in practicing the present disclosure include water soluble flocculating polymers such as polyacrylamides or copolymers thereof such as nonionic polyacrylamides and copolymers thereof, an anionic polyacrylamide (APAM) such as a polyacrylamide-co-acrylic acid, and a cationic polyacrylamide (CPAM), which can contain co-monomers such as acryloxyethyltrimethyl ammonium chloride, methacryloxyethyltrimethyl ammonium chloride, dimethyldiallyammonium chloride (DMDAAC), etc. Other water-soluble flocculating polymers useful for practicing the present disclosure include a polyamine, such as a polyamine or quaternized form thereof, e.g., polyacrylamide-co-dimethylaminoethylacrylate in quaternized form, a polyethyleneimine, a polydiallyldimethyl ammonium chloride, a polydicyandiamide, or their copolymers, a polyamide-co-amine, polyelectrolytes such as a sulfonated polystyrenes can also be used. Other water-soluble polymers such as polyethylene oxide and its copolymers can also be used. The polymer flocculants can be synthesized in the form of a variety of molecular weights (MW), electric charge types and charge density to suit specific requirements. Advantageously, the flocculating polymer used in practicing processes of the present disclosure do not include use of activated polysaccharides or activated starches, i.e., polysaccharides and starches that have been heat treated, in sufficient amounts to lower the density of the floc to below the density of the tailings water from which they are separated. Such activated polysaccharides and activated starches when used in sufficiently high dosages tend to form low density flocs which rise to the surface of an aqueous composition, which can cloud overflow liquid.

The amount of polymer(s) used to treat a slurry should preferably be sufficient to flocculate the solids in the feed slurry. The amount of polymer(s) used to treat feed slurry can be characterized as a dosage based on the weight percent of the solids in the feed slurry. In some embodiments of the present disclosure, one or more polymer flocculant(s) can be used to treat feed slurry at a dosage (weight of the flocculant(s) to weight of the solids in the slurry) of no less than zero and up to about 0.005 wt %, e.g., up to about 0.01 wt % and in some implementations up to about 0.015 wt %, 0.020 wt %, 0.025 wt %, 0.03 wt %, or 0.04 wt %.

Because indifferent salts and polymer flocculants that are preferably water soluble are used in the process of the present disclosure, the temperature of thickening slurries in a thickener apparatus need not be elevated above ambient temperature to practice the process. In certain embodiments, treating a feed slurry according to the various embodiments herein can be carried out at about ambient temperature or no more about 2 to about 5° C. above ambient temperature.

In practicing aspects of the present process, thickening slurry includes treating a feed slurry with an indifferent salt or solution thereof in a thickener apparatus including a sediment tank and separating and recovering overflow aqueous liquid, e.g. clarified water, from the sediment tank after treating the feed slurry. The process can include combining a feed slurry with a concentration greater than 2 wt % solids, such as greater than 15 wt % and even greater than 20 wt % solids and higher such as 50%, with an indifferent salt in the feed. With sufficient concentration of the indifferent salt in the aqueous phased of the feed slurry, the solids settle to the bottom of the tank under the pull of gravity and can be pushed towards the outlet port by rakes. Advantageously, the solids loading rate for a feed slurry to be treated with an indifferent salt and optionally polymer flocculant can be greater than 1.0 (t/h)/m², such at least about 2.5 (t/h)/m² and at least about 3, 3.5, 4, 4.5, 5 and 6 (t/h)/m². As the result of the possibility to feed the liquid-solids separation unit at a higher solids concentration by using an indifferent salt with polymer and because of the higher solids loading rates achievable, substantially less liquid-solids separation surface are will be required, reducing either the size or the number of the units required, thus reducing the capital and operating cost requirement substantially.

Clarified water can exit a thickener sediment tank through an overflow port or lip of the tank. Conventional overflow clarity is typically in the range of 500 ppm to 5000 ppm. But to achieve such low overflow clarity, the solids loading rate is relatively kept low. An advantage of the present disclosure is that even with a very high solids loading rates (e.g., at least about 4, 5 and 6 (t/h)/m², the overflow clarity remains lower than 5000 ppm, such as lower than 2500 ppm, 1000 ppm and even lower than 500 ppm or 300 ppm. Such overflow clarity can be determined by a turbidity detector. A reduction in overflow clarity reduces upstream and downstream complications that would have been caused by the presence of suspended solids. The reduction in suspended solids eliminates a build-up of slimes within the process, introducing also a circulating load. Slimes increase the reagent consumption. Slimes also change the rheology of the slurries, thus impacting extraction processes negatively. Downstream slimes can be the cause of impurities being introduced, requiring expensive cleaning process steps. Substantial savings are therefore realized through the production of a clear pregnant solution recovery in the liquid-solids separation step.

Settling performance and the final solids content of the settled solids (thickener underflow slurry) is enhanced by the indifferent salt at sufficient concentration in the slurry. An advantage of treating feed slurry with an indifferent salt according to aspects of the present disclosure is that a rise rate of treated feed slurry can be very low even with a high solids loading rate because of being able to process a high feed solids concentration, otherwise not possible. For example, a rise rate of treated feed slurry can be less than 3 (meter/hour) (m/h) at a solids loading rate (t/h)/m² between about 3 to 6 and even less than 2 m/h at a solids loading rate about 1.5 (t/h)/m². The possibility of feeding the liquid-solids separation units at a high solids concentration results in the use of smaller units thus substantially reducing the capital and operating costs.

Advantageously, since the indifferent salt is highly water-soluble salt, the indifferent salt remains almost entirely in the aqueous phase of the treated feed slurry and can be recovered with overflow aqueous liquid, e.g. clarified water, from the sediment tank after treating the feed slurry. In certain embodiments of the present disclosure, the overflow liquid, e.g. clarified water, recovered from the treated feed slurry has a concentration of the indifferent salt that is similar to the concentration of the indifferent salt in the treated feed slurry. Some loss of indifferent salt may be due to loss with removing underflow slurry. However, it is preferable that the directly recovered overflow aqueous liquid has a concentration of the indifferent salt dissolved therein of at least about 0.4 wt %, such as at least 0.5 wt % and preferably no less than about 0.70 wt %, such as at least about 1 wt %, etc. The separated overflow liquid including the dissolved indifferent salt can be used to treat additional tailings in the thickener apparatus. In addition, the separated overflow liquid including the dissolved indifferent salt can be concentrated prior to use to treat additional feed slurry such as by nano filtration, reverse osmosis, combinations thereof, etc.

Advantageously, the treatment of the leach residue with indifferent salt and polymer improves the consolidation rate in thickening, filtration and later in the filter storage facility.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention and are covered by the following claims.

1. A process of leaching a metal from a feed source, the process comprising:
combining the feed source with a leaching reagent and an indifferent salt in a leach medium to form a feed slurry;
leaching a metal or metal salt from the feed slurry to form a leach slurry containing a pregnant leach liquor having metal salts dissolved therein and leach solids residue;
separating the pregnant leach liquor from the leach solids residue;
recovering the metal salts from the pregnant leach liquor and forming a residual leach solution having a concentration of the indifferent salt dissolved therein of at least about 0.4 wt %; and
recycling the residual leach solution to form additional feed slurry.

2. The process of claim 1, wherein a concentration of the indifferent salt dissolved in the leach medium is no less than 1 wt %.

3. The process of claim 1, further comprising introducing a slurry generated in the process to a thickener apparatus to separate the slurry into an underflow slurry and an overflow liquid with an increase in liquid-solids separation rate and/or efficiency of at least 25% as compared to the feed slurry in the thickener apparatus without the added indifferent salt.

4. The process of claim 1, wherein the feed slurry is formed at a rate of at least two metric tonnes in a 24 hour period and the separating of the pregnant leach liquor from the leach solids residue occurs directly from the leached slurry by filtration without a prior thickening step.

5. The process of claim 1, wherein the feed slurry is formed at a rate of at least two metric tonnes in a 24 hour period and the separating of the pregnant leach liquor from the leach solids residue occurs when the leach slurry has a solids concentration of greater than 10 wt % solids.

6. The process of claim 1, wherein the feed slurry is formed at a rate of at least two metric tonnes in a 24 hour period and the recovering of the metal salts from the pregnant leach liquor includes separating metal salts from the pregnant leach liquor in a product slurry having a solids concentration of greater than 10 wt % solids.

7. The process of claim 6, wherein the separating of the metal salts from the pregnant leach liquor in the product slurry occurs directly from the product slurry by filtration without a prior thickening step.

8. The process of claim 1, wherein the indifferent salt is an alkali halide.

9. The process of claim 1, wherein the feed source includes a lithium containing sedimentary rock.

10. The process of claim 7, wherein the leach medium is at a temperature of at least 30° C.

11. The process of claim 7, wherein water for the leach medium or the leach medium is heated by a natural source.

12. The process of claim 10, wherein the indifferent salt comprises an alkali halide.

13. The process of claim 1, wherein the recycling of the residual leach solution includes combining the residual leach solution with the feed source to form the additional feed slurry.

14. The process of claim 1, wherein the indifferent salt comprises at least one selected from sodium chloride, potassium chloride, sodium nitrate, potassium nitrate, sodium phosphate, potassium phosphate, sodium sulfate, potassium sulfate, ammonium chloride, ammonium bromide, ammonium carbonate, ammonium bicarbonate, ammonium nitrate, ammonium sulfate, ammonium hydrogen sulfate, ammonium dihydrogen phosphate, ammonium hydrogen phosphate, and ammonium phosphate.

15. A process of leaching a metal from a feed source, the process comprising:
combining the feed source with a leaching reagent and a salt in a leach medium to form a feed slurry, wherein the salt is at least one selected from sodium chloride, potassium chloride, sodium nitrate, potassium nitrate, sodium phosphate, potassium phosphate, sodium sulfate, potassium sulfate, ammonium chloride, ammonium bromide, ammonium carbonate, ammonium bicarbonate, ammonium nitrate, ammonium sulfate, ammonium hydrogen sulfate, ammonium dihydrogen phosphate, ammonium hydrogen phosphate, and ammonium phosphate;
leaching a metal or metal salt from the feed slurry to form a leach slurry containing a pregnant leach liquor having metal salts dissolved therein and leach solids residue;
separating the pregnant leach liquor from the leach solids residue;
recovering the metal salts from the pregnant leach liquor and forming a residual leach solution having a concentration of the salt dissolved therein of at least about 0.4 wt %; and
recycling the residual leach solution to form additional feed slurry,
wherein a concentration of the salt dissolved in the leach medium is no less than 1 wt %,
wherein the feed slurry is formed at a rate of at least two metric tonnes in a 24 hour period, and
wherein the recycling of the residual leach solution includes combining the residual leach solution with the feed source to form the additional feed slurry.

16. The process of claim 15, further comprising introducing a slurry generated in the process to a thickener apparatus to separate the slurry into an underflow slurry and an overflow liquid with an increase in liquid-solids separation rate and/or efficiency of at least 25% as compared to the feed slurry in the thickener apparatus without the added salt.

17. The process of claim 15, wherein the separating of the pregnant leach liquor from the leach solids residue occurs directly from the leached slurry by filtration without a prior thickening step.

18. The process of claim 15, wherein the separating of the pregnant leach liquor from the leach solids residue occurs when the leach slurry has a solids concentration of greater than 10 wt % solids.

19. The process of claim 15, wherein the recovering of the metal salts from the pregnant leach liquor includes separating metal salts from the pregnant leach liquor in a product slurry having a solids concentration of greater than 10 wt % solids.

20. The process of claim 19, wherein the separating of the metal salts from the pregnant leach liquor in the product slurry occurs directly from the product slurry by filtration without a prior thickening step,
wherein the feed source includes a lithium containing sedimentary rock,
wherein the leach medium is at a temperature of at least 30° C., and
wherein water for the leach medium or the leach medium is heated by a natural source.
